(19) United States
(12) Patent Application Publication
(10) Pub. No.: US 2024/0386263 A1
(43) Pub. Date: Nov. 21, 2024

(54) MACHINE LEARNING FOR SOLVING QUANTUM ANNEALING HARDWARE MINOR EMBEDDING PROBLEMS

(71) Applicant: Dell Products L.P., Round Rock, TX (US)

(72) Inventors: Miguel Paredes Quiñones, Campinas (BR); Brendan Burns Healy, Haddonfield, NJ (US); Italo Gomes Santana, Rio de Janeiro (BR)

(21) Appl. No.: 18/320,531

(22) Filed: May 19, 2023

(51) Int. Cl. G06N 3/08; G06N 10/40; G06N 10/60

(52) U.S. Cl. CPC G06N 3/08; G06N 10/40; G06N 10/60

(57) ABSTRACT

A method for solving quantum annealing hardware minor embedding problems using machine learning includes determining, by a system including a processor, a logical qubit graph, where the logical qubit graph represents logical qubits and logical connections between the logical qubits. The method also includes determining, by the system and via a machine learning model associated with a quantum computer, mapping data representative of a mapping between the logical qubit graph and a physical qubit graph, where the machine learning model is trained with training data that is representative of logical to physical qubit embeddings previously deployed on the quantum computer, and where the physical qubit graph represents physical qubits of the quantum computer and physical connections between the physical qubits.

### BACKGROUND

Annealing hardware, such as quantum annealing (QA) hardware, is a modern alternative to gate-based computing that works on the principle of least energy. Physical nodes are configured with a binary property intended to mock a traditional 0/1 value of a bit. Often such a node is an electron, and the binary property is spin (which represents the state of a component of a quantum physical system) which may be either up or down. The physical surroundings of these nodes, e.g., qubits, are then manipulated in such a way to mimic the configuration of a given logical problem.

Additionally, the minor embedding problem in QA hardware is a mapping between a problem graph, which is usually highly connected, and the real hardware graph representing the quantum annealer, which is typically much less well-connected. Variables can be considered connected in the problem graph of an optimization problem, e.g., an optimization problem associated with a quantum annealer, if they are related to each other by a constraint or a nonzero term in the objective function.

### SUMMARY

The following summary is a general overview of various embodiments disclosed herein and is not intended to be exhaustive or limiting upon the disclosed embodiments. Embodiments are better understood upon consideration of the detailed description below in conjunction with the accompanying drawings and claims.

In an implementation, a system is described herein. The system can include a memory that stores executable components and a processor that executes the executable components stored in the memory. The executable components can include a prediction engine component that determines, via a machine learning (ML) model associated with a quantum hardware device and based on a logical graph corresponding to logical qubits and logical connections between the logical qubits, a mapping from the logical graph to a physical graph. The physical graph can correspond to physical qubits of the quantum hardware device and physical connections between the physical qubits. Additionally, the ML model can be trained via a model training component using minor embedding data, and the minor embedding data can be representative of logical to physical qubit mappings previously used by the quantum hardware device.

In another implementation, a method is described herein. The method can include determining, by a system including a processor, a logical qubit graph, where the logical qubit graph represents logical qubits and logical connections between the logical qubits. The method can further include determining, by the system and via a ML model associated with a quantum computer, mapping data representative of a mapping between the logical qubit graph and a physical qubit graph. The ML model can be trained with training data that is representative of logical to physical qubit embeddings previously deployed on the quantum computer. Additionally, the physical qubit graph can represent physical qubits of the quantum computer and physical connections between the physical qubits.

In an additional implementation, a non-transitory machine-readable medium is described herein that can include instructions that, when executed by a processor, facilitate performance of operations. The operations can include receiving problem graph data representative of a problem graph including logical qubits and logical connections between the logical qubits; and determining, via a neural network generated for a quantum computing device, mapping data representative of a mapping from the problem graph to a physical qubit graph, where the neural network is trained using minor embedding data representative of logical to physical qubit mappings previously used by the quantum computing device, and where the physical qubit graph is representative of physical qubits of the quantum computing device and physical connections between the physical qubits.

### DESCRIPTION OF DRAWINGS

Various non-limiting embodiments of the subject disclosure are described with reference to the following figures, wherein like reference numerals refer to like parts throughout unless otherwise specified.

FIG. 1 is a block diagram of a system that facilitates machine learning for solving quantum annealing hardware minor embedding problems in accordance with various implementations described herein.

FIG. 2 is a diagram depicting an example problem graph and corresponding mapped physical graph on a quantum annealing device in accordance with various implementations described herein.

FIG. 3 is a diagram depicting a matrix representation of an example graph in accordance with various implementations described herein.

FIG. 4 is a diagram depicting collection of results from problem graphs using a defined algorithm in accordance with various implementations described herein.

FIGS. 5-7 are block diagrams of respective systems that facilitate execution of a mapped physical qubit graph on an associated quantum annealer in accordance with various implementations described herein.

FIG. 8 is a diagram depicting a pipeline of execution of an example model with a quantum annealer in accordance with various implementations described herein.

FIG. 9 is a block diagram depicting example functions that can be performed by a prediction engine component in accordance with various implementations described herein.

FIG. 10 is a block diagram of a system that facilitates supplementation of model training data with prediction engine output in accordance with various implementations described herein.

FIG. 11 is a flow diagrams of a method that facilitates machine learning for solving quantum annealing hardware minor embedding problems in accordance with various implementations described herein.

FIGS. 12-13 are flow diagrams of respective methods that facilitate execution of a mapped physical qubit graph on an associated quantum annealer in accordance with various implementations described herein.

FIG. 14 is a diagram of an example computing environment in which various implementations described herein can function.

### DETAILED DESCRIPTION

Various specific details of the disclosed embodiments are provided in the description below. One skilled in the art will recognize, however, that the techniques described herein can in some cases be practiced without one or more of the specific details, or with other methods, components, materials, etc. In other instances, well-known structures, materials, or operations are not shown or described in detail to avoid obscuring subject matter.

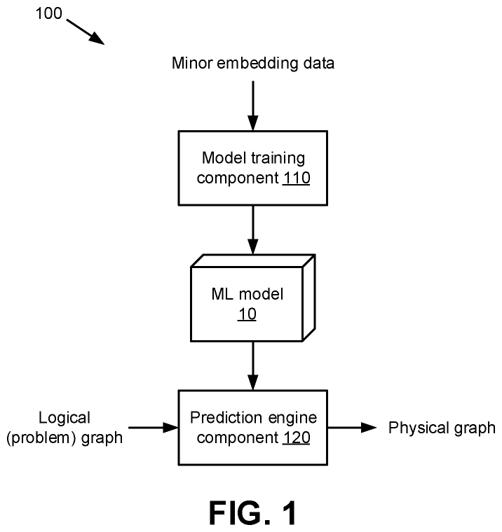

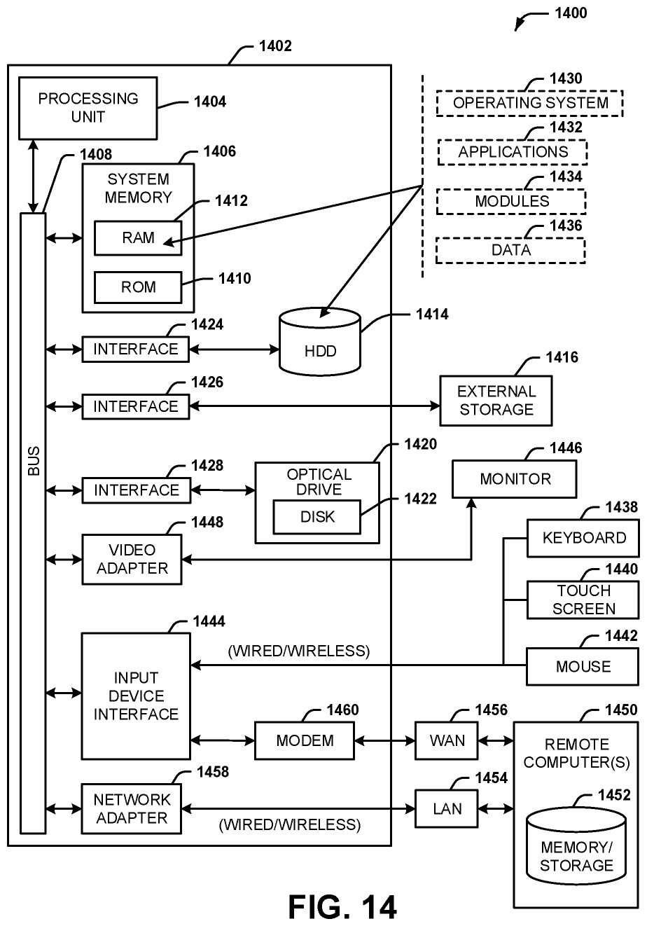

With reference now to the drawings, FIG. 1 illustrates a block diagram of a system 100 that facilitates that facilitates machine learning for solving quantum annealing (QA) hardware minor embedding problems in accordance with various implementations described herein. System 100 as shown in FIG. 1 includes a model training component 110 and a prediction engine component 120, which can operate as described in further detail below. In an implementation, the components 110, 120 of system 100 can be implemented in hardware, software, or a combination of hardware and software. By way of example, the components 110, 120 can be implemented as computer-executable components, e.g., components stored on a memory and executed by a processor. An example of a computer architecture including a processor and a memory that can be used to implement the components 110, 120, as well as other components as will be described herein, is shown and described in further detail below with respect to FIG. 14. Additionally, it is noted that while system 100 as shown in FIG. 1 includes both a model training component 110 and a prediction engine component 120, the model training component 110 and its associated functionality need not be present in system 100 in all implementations. For example, in some implementations, the model training component 110 can be external to system 100 and can communicate with system 100 via a wired and/or wireless network connection.

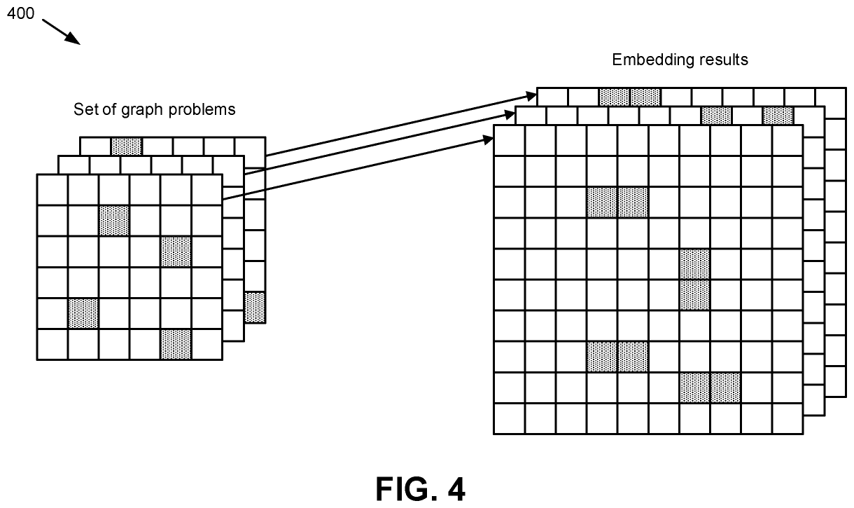

With regard to the components 110, 120 shown in FIG. 1, the model training component 110 can train a machine learning (ML) model 10, that is associated with a quantum computer or other quantum hardware device, using training data that includes minor embedding data. Here, the minor embedding data is representative of logical to physical qubit mappings previously utilized by the quantum hardware device, e.g., in association with previous iterations of the minor embedding problem as will be described in further detail below with respect to FIG. 4.

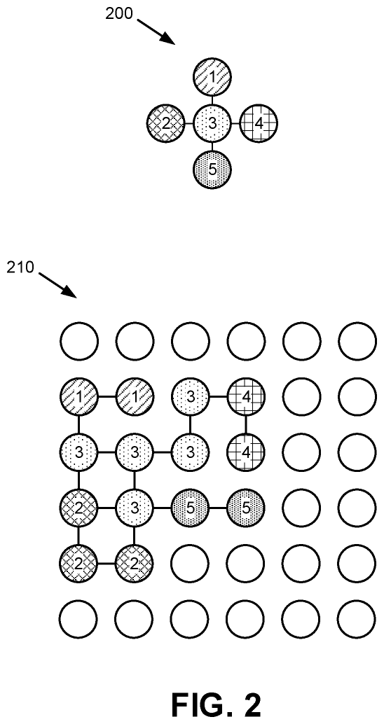

The prediction engine component 120 of system 100 can determine, e.g., via the ML model 10 trained by the model training component 110, a mapping from a logical graph to a physical graph. Here, the logical graph is provided as input to the prediction engine component 120 and corresponds to logical qubits and logical connections between the qubits. A logical graph can also be referred to as a problem graph, e.g., a graph of the logical qubits and connections associated with a given computing problem. The physical graph generated by the prediction engine component 120 can correspond to physical qubits of the particular quantum hardware device associated with the ML model 10 as well as physical connections between those physical qubits. An example of a logical (problem) graph and a corresponding physical graph is described in more detail below with respect to FIG. 2.

As will be described in further detail below, the ML model 10 shown in system 100 can be a graph neural network (GNN) and/or any other suitable model that can operate on the basis of graph input. Additionally, while not shown in FIG. 1 for purposes of brevity, the model training component 110 can train and/or otherwise maintain multiple ML models 10, each of which can be tailored to a particular quantum computer or other hardware device. For instance, a first ML model 10 can be trained by the model training component 110 to map problem graphs onto a particular physical configuration of a first quantum computer, and a second ML model 10 can be trained by the model training component 110 to map the same and/or other problem graphs onto a second, different quantum computer.

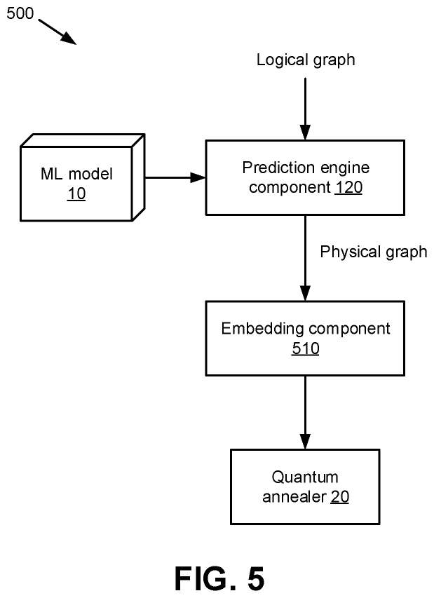

In implementations in which multiple ML models 10 are used, one or more prediction engine components 120 can be used to solve minor embedding problems for respective quantum computing devices based on the provided ML models 10. For example, each ML model 10 can be associated with its own prediction engine component 120, e.g., in an implementation in which the prediction engine component resides on, or is otherwise associated with, a particular quantum computing device. Alternatively, multiple ML models 10 can be utilized by a single prediction engine component 120, e.g., in an implementation in which the prediction engine component 120 is associated with a standalone device that provides functionality for multiple quantum hardware devices. Various examples of implementations that can be utilized for the prediction engine component, as well as for implementing determined physical graphs on an associated quantum annealer, are described in further detail below with respect to FIGS. 5-7.

As noted above, the minor embedding problem in QA hardware involves finding a mapping between a problem graph and a real hardware graph representing a quantum annealer. The challenge in solving minor embedding problems arises due to connectivity limitations in actual quantum annealer hardware, since connecting all qubits in a quantum annealer, i.e., achieving full connectivity in a real quantum annealer, currently presents significant technical challenges.

As used herein, a representation of an original problem graph is called a logical graph, and the real hardware graph noted above is called a physical graph. The physical graph is a subgraph of the device graph, which expresses the native connectivity of qubits in a specific hardware. A physical graph is usually larger than a corresponding logical graph since some nodes of the physical graph may need to be aggregated to represent the same connectivity of the logical graph. This aggregation of nodes is referred to as a chain, and minor embedding algorithms seek to generate an embedding of the logical graph into the physical graph that minimizes chain sizes. The resulting (minor) embedding of these algorithms is desirably as minimal as possible in order to permit quantum annealers to handle logical graphs that are as large as possible. This objective can be achieved in part by avoiding redundant connections of physical qubits in representing a corresponding logical qubit.

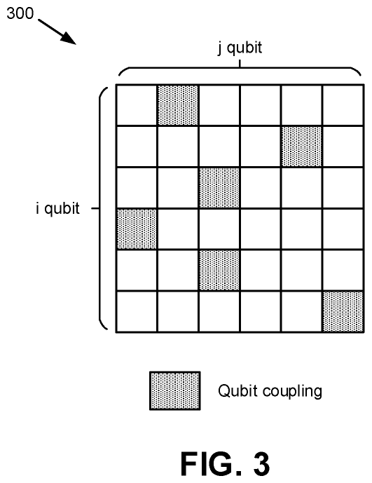

A given quantum physical system can be represented by a Hamiltonian matrix, also referred to herein as simply a Hamiltonian, which expresses the energy of the corresponding system given a state of the system. For instance, a Hamiltonian can be used to encode a state of a given quantum physical system into a vector of binary variables, e.g., as will be discussed in further detail below with respect to FIG. 3. However, due to the present technical limitations associated with QA hardware that prevent full physical connectivity as noted above, a goal of the minor embedding problem is to find a matrix that can be represented in a given quantum hardware device that has the same energy as the Hamiltonian corresponding to the original quantum system. Stated another way, in a minor embedding, the solution of the Hamiltonian generated by the physical graph desirably corresponds to the solution of the Hamiltonian generated by the logical graph.

To the furtherance of the above and/or related ends, various implementations described herein provide new ways of facilitating translation between a logical graph to a physical graph, e.g., by using graph neural networks (GNNs) to aggregate nodes on the device graph for a given physical system. The implementations described herein can act as a classical preprocessing step for quantum annealers, and can be utilized to enable the encoding of problems using classical computing to run on quantum annealers. This can, for example, reduce the cost of implementing logical qubit systems on real hardware, e.g., in terms of time, monetary cost, computational and/or processing cost, and/or other measures associated with such implementations. Implementations described herein can further improve the efficiency of quantum computing devices, e.g., by providing higher-quality minor embeddings than are generally achievable via existing algorithms or techniques. Other advantages of the implementations described herein are also possible.

As further described above, QA hardware works on the principle of least energy and is associated with physical nodes are configured with a binary property intended to mock a traditional 0/1 value of a bit. For instance, a physical node, e.g., a qubit, can correspond to an electron, where the binary property is spin (which represents the state of a component of a quantum physical system) which may be either up or down. The physical surroundings of these qubits can then be manipulated in such a way to mimic the configuration of a logical problem, and the manner of doing so can reflect an optimization problem to be solved by the device.

Because of the specialized nature of QA hardware, the above problem is desirably expressible in a format known as quadratic unconstrained binary optimization (QUBO). In general, the operations performed by an annealer can be defined as an optimization problem, the solution to which can be reflected by the physical reality of the qubits.

While most gate-based processors operate on several dozen bits at once, annealers may house thousands, tens of thousands, or even occasionally hundreds of thousands of qubits. Due to the physical constraints of managing so many different nodes in a quantum system, it is presently not possible to treat all possible pairs of qubits in a single operation. Indeed, only a small handful of these pairings may be possible for a given system. A device graph, which represents qubits as nodes and possible couplings between qubits as edges, can be referred to as the topology of the device. The topology of a given device is a physical restriction on computation, since it represents the physical capabilities of a given hardware.

Quantum annealers can have connections between physical qubits called couplers, where a coupler permits the two qubits in a pair to interact with each other. Due to hardware implementation of these couplings, quantum hardware faces physical restrictions which do not allow for all qubits to be fully connected. Instead, quantum annealer manufacturers can choose graphs which are as general as possible to try to accommodate the widest range of embeddings of logical graphs.

Due to these limitations, it is desirable to facilitate a translation from an original graph problem to a device graph. For instance, as shown in FIG. 2, diagram 200 shows a graph problem where each node represents a logical qubit (here, qubits 1 through 5) and each edge represents a nonzero multiplication between two qubits (e.g., a coupler in the hardware). Based on this representation, the problem graph represents the following quadratic function (assuming all coefficients are 1, for simplicity):

$$f ( x ) = {x}_{1} \cdot {x}_{3} + {x}_{2} \cdot {x}_{3} + {x}_{4} \cdot {x}_{3} + {x}_{5} \cdot {x}_{3} .$$

The corresponding physical graph, represented by diagram 210 in FIG. 2, has repeated nodes since some of the nodes do not have direct connections between each other. Couplers that connect physical qubits that represent the same logical qubit are called intra-couplers, and couplers that connect different chains are called inter-couplers. Additionally, it is noted that the presence of repeated nodes in the physical graph represented by diagram 210 can facilitate qubit redundancy to improve the accuracy of the physical system, e.g., by reducing the impact of potential noise in the creation of a physical qubit and/or other factors.

The complexity of the minor embedding problem is in part due to the combinatorial explosion of potential embedding candidates, which can expand exponentially with the size of the logical graph. Because modern annealers can work with tens or hundreds of thousands of qubits, this combinatorial explosion can significantly outstrip the capacity of exact solvers. The minor embedding problem is also specific to each hardware, as the physical graph used depends on the annealer for a given hardware system. For instance, different quantum annealer vendors can choose different topologies for their processors depending on coupler fidelity, qubit size, noise, and/or other factors. As a result, it is exceedingly difficult to develop a one-size-fits-all methodology for solving the embedding problem in a hardware-agnostic manner.

Returning to system 100 in FIG. 1, system 100 can be used to solve the minor embedding problem on a per-device basis. The solution provided by system 100 can be based on machine learning and solve the physical to logical mapping by, e.g., learning how conventional minor embedding algorithms are implemented on existing quantum annealing devices. An example procedure that can be utilized by system 100 in this manner is summarized below:
1. Collect data from solutions of minor embedding algorithms (e.g., classical minor embedding algorithms) previously used on QA hardware for a specific quantum hardware. This can include, e.g., obtaining the problem graph Gₚ(Vₚ, Eₚ) and its corresponding embedding in the physical graph G_{ƒ}(V_{ƒ}, E_{ƒ}), where V represents graph vertices and E represents graph edges. The entire hardware topology Gₕ(Vₕ, Eₕ) can also be considered to construct the GNN model M, which can be device specific.
2. Derive hyper parameters for the architecture corresponding to M, e.g., the number of inputs, weights, layers, etc., from the hardware graph Gₕ(Vₕ, Eₕ) to represent the specific architecture.
3. Train M with the collected data from step 1 above. In an implementation, M can be associated with a loss function that is expected to relate G_{ƒ}(V_{ƒ}, E_{ƒ}) to the problem graph Gₚ(Vₚ, Eₚ) given as test data. Additionally, a second term can be added to the loss function to minimize the number of physical nodes that represent a problem node. Loss functions that can be associated with a given model M are described in further detail below.
4. Use M to predict the physical graph G_{ƒ}(V_{ƒ}, E_{ƒ}) for a given problem graph Gₚ(Vₚ, Eₚ), and run G_{ƒ}(V_{ƒ}, E_{ƒ}) on its corresponding quantum annealer. Techniques that can be utilized to run a physical graph that is predicted in this manner are described in further detail below with respect to FIGS. 5-7.

It is noted that the above is merely one example of a procedure that can be utilized by system 100, and that other procedures, e.g., with omitted and/or replaced steps from the above-described procedure, could also be used in accordance with various implementations as will be described herein.

In an implementation, data collection for a ML model 10, e.g., as described in step 1 above, can be performed by the model training component 110 and/or other suitable executable components. In the following description, a graph is represented via a matrix representation as shown in diagram 300 of FIG. 3, where an interaction between two qubits is represented as a non-zero element. In diagram 300, zero elements of the matrix are unshaded, and non-zero elements of the matrix are shaded. Similar matrix-graph representations can be utilized for each graph referenced in this description.

Turning now to diagram 400 in FIG. 4, and with further reference to system 100 in FIG. 1, an algorithm A, e.g., an existing (classical) minor embedding algorithm, can be used to generate an embedding in the physical graph G_{ƒ}(V_{ƒ}, E_{ƒ}) from its corresponding problem graph Gₚ(Vₚ, Eₚ), e.g., as illustrated by diagram 400. In an implementation, the algorithm A used in this step can be chosen to obtain good (e.g., in terms of quality) solutions irrespective of algorithm running time. Since the embedding problem is a computationally hard problem (i.e., a nondeterministic polynomial time (NP) problem), the expectation is that running times associated with obtaining a high-quality solution via algorithm A are prohibitive. The quality of a given solution, i.e., the qualification of a “good” solution, can take into account respective aspects that include, but are not necessarily limited to, the following:
1. Less mean number of physical qubits representing a logical qubit.
2. Better (e.g., according to various objective criteria) final objective functions when the addressed problem is solved by a quantum annealer.
3. Less final noise at the embedding physical graph.

Additionally, graphs representing respective QA hardware implementations i can be collected, e.g., graphs Gₕ(Vₕ, Eₕ)ᵢ, where an embedding problem using algorithm A was used.

Collected data as described above can then be used to train the ML model 10, referred to herein as model M. Here, model M is defined as a GNN that will learn how to produce minor graph embeddings from problem graphs in reasonable time (e.g., less time than algorithm A noted above and/or other existing minor embedding algorithms). This knowledge can be extracted from the solutions given by algorithm A, e.g., as described above, and can be used to improve the quality of a solution given by algorithm A by introducing a regularization term on the loss function during the training of model M, e.g., to reduce the number of qubits that appear in the final embedding graph G_{ƒ}(V_{ƒ}, E_{ƒ}).

Based on the above, an example final loss function for model M during the training can be expressed as follows:

$$ℒ = {‖ M ( {G}_{p} , {G}_{h} ) - {G}_{f} ‖}_{F} + λ {‖ M ( {G}_{p} , {G}_{h} ) ‖}_{F} ,$$

where ∥.∥F is the Frobenius norm of a matrix and A is a weight that regularizes the number of qubits at the final graph embedding generated by model M. Additionally, the loss function [symbol] can be minimized across all of the data collected as described above for a given hardware.

It is noted that the above loss function is merely an example of a function that can be utilized in training the ML model 10 and that other functions, e.g., loss functions, reward functions, etc., could be used. In some implementations, the ML model 10 can be trained using a loss function that contains a first term relating to a level of correlation between a given logical graph and its corresponding mapped physical graph and a second term relating to the number of physical qubits assigned to each logical qubit, e.g., to minimize the number of physical qubits in the final mapped physical graph. Other functions could also be used.

As a result of the above steps, model M can be trained and capable of producing embedding graphs coming from problem graphs Gₚ for a desired hardware of a quantum annealer. Additionally, model M can enable the solution of a quadratic binary optimization problem embedded in graph Gₚ to be agnostic with respect to a desired quantum annealer vendor, which can in turn enable multiple models to be trained for different vendors and used as a middle step to send the embedding graph to the vendor. In doing so, the embedding problem can be decentralized and run in classical infrastructure.

Turning now to FIG. 5, a block diagram of a system 500 that facilitates execution of a mapped physical qubit graph on an associated quantum annealer 20 is illustrated. Repetitive description of like parts described above with regard to other implementations is omitted for brevity. System 500 as shown in FIG. 5 includes a prediction engine component 120, which can determine a logical to physical qubit mapping as described above, resulting in a physical qubit graph. System 500 further includes an embedding component 510 that can enable execution of the physical qubit graph via a quantum annealer 20, e.g., a quantum annealer 20 associated with a quantum hardware device corresponding to the physical qubit graph.

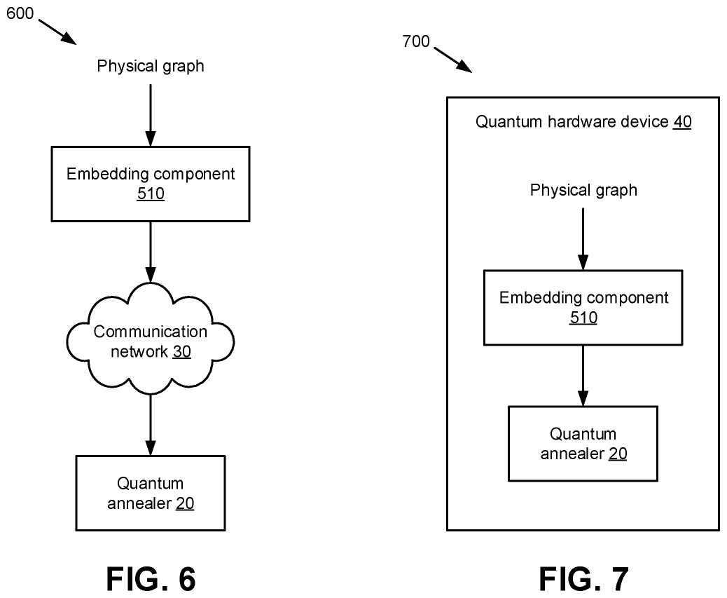

Referring next to FIGS. 6-7, respective example implementations of the embedding component 510 are illustrated. The two example implementations shown in FIGS. 6-7 differ primarily in the location of the device running the solution and/or the entity that owns the compute performing it. Additionally, it is noted that other implementations from those shown in FIGS. 6-7 are also possible.

With reference first to FIG. 6, system 600 represents an implementation in which the embedding component 510 is communicatively coupled to a quantum hardware device, e.g., a quantum hardware device associated with a quantum annealer 20, via a communication network 30. Based on this configuration, the embedding component 510 can facilitate implementation of a physical graph on the quantum annealer 20 by transferring the physical graph to the quantum annealer 20 via the communication network 30.

In an implementation, the embedding component 510 of system 600 can be a broker application, e.g., a middleware broker, that operates on servers and/or other computing devices that are distinct from a quantum computing device that utilizes the quantum annealer 20. In some implementations, the embedding component 510, and/or the server(s) on which the embedding component 510 runs, can host and maintain models (e.g., ML models 10) representing multiple different quantum annealers corresponding to different quantum computing devices. An implementation such as that shown by system 600 can simplify operations for annealing vendors, e.g., by reducing the burden to allocate additional machines with their QA hardware, which can be difficult in some cases due to practical limitations imposed on quantum behavior. Additionally, the implementation shown by system 600 can improve quantum computing performance in terms of resource allocation, efficiency (e.g., in terms of computing time, monetary cost, etc.), and/or other criteria.

Referring next to FIG. 7, system 700 represents an alternative implementation where the embedding component 510 is incorporated with a given quantum hardware device 40. While the embedding component 510 is shown in system 700 as part of the quantum hardware device 40, the embedding component could be operatively coupled to the quantum hardware device 40 in other ways. For instance, the embedding component 510 could be provided via a server that is attached to the quantum hardware device 40 on the premises of the quantum hardware device 40. Based on the configuration shown by system 700, the embedding component 510 can execute (either directly or indirectly) a given physical graph associated with the quantum hardware device 40 via a quantum annealer 20 of the quantum hardware device 40. An implementation as shown by system 700 can enable a quantum computing vendor to tailor the configuration of a ML model associated with the quantum hardware device 40 based on the specific needs of the quantum hardware device 40.

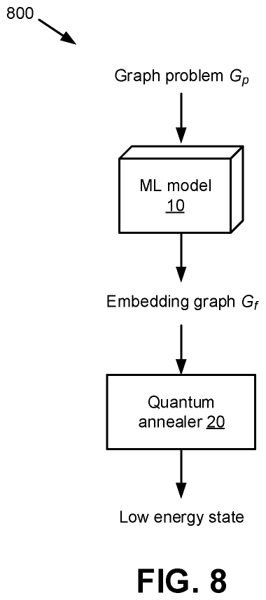

Referring next to FIG. 8, a diagram 800 depicting a pipeline of execution of an example ML model 10 with a quantum annealer 20 is provided. Repetitive description of like parts described above with regard to other implementations is omitted for brevity. In particular, diagram 800 illustrates an example pipeline of execution for a given ML model 10 and quantum annealer 20. In the pipeline shown by diagram 800, a graph problem is provided as input to the ML model 10 to produce an embedding graph as output. The embedding graph can then be executed on the quantum annealer 20, resulting in a low energy state.

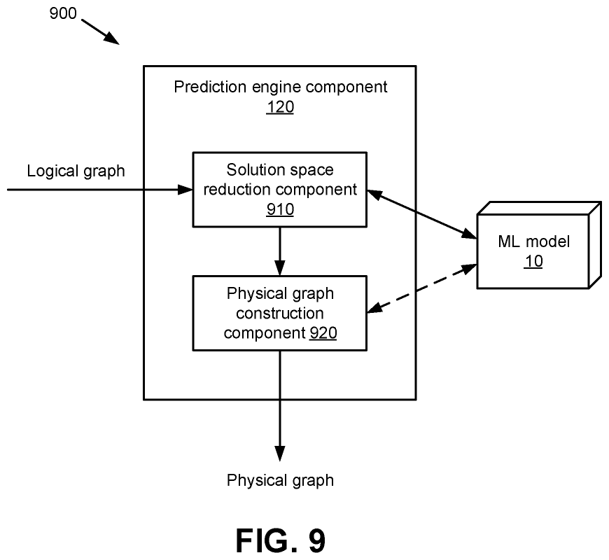

Turning to FIG. 9, a block diagram 900 depicting example functions that can be performed by a prediction engine component 120 is illustrated. Repetitive description of like parts described above with regard to other implementations is omitted for brevity. As generally described above, the prediction engine component 120 can perform minor embedding problems using GNNs and/or other ML models, e.g., ML model 10, to obtain quick physical-equivalent graphs on QA devices. This can be relevant, e.g., for QA users to translate graph problems into a specific device graph.

As additionally shown by diagram 900, the prediction engine component 120 can include respective subcomponents, such as a solution space reduction component 910 and a physical graph construction component 920, which can facilitate a two-step process for determining a physical graph corresponding to a given logical graph. While the solution space reduction component 910 and physical graph construction component 920 are illustrated in FIG. 9 as part of the prediction engine component 120, it is noted that these components could also operate separately from the prediction engine component 120.

In an implementation, system 900 can be utilized to prune the search space of possible embeddings in algorithms for the minor embedding problem. For instance, instead of predicting a resulting solution for the minor embedding problem, the prediction engine component 120, via the ML model 10, can predict the likelihood of each physical node occurring in a high-quality embedding for each logical node. Stated another way, the prediction engine component 120 can determine probability values representative of the likelihood of respective physical qubits and physical connections between the physical qubits being present in a given physical graph.

Based on probability values as described above and/or other likelihood information generated via the ML model 10 and/or the prediction engine component 120, the solution space reduction component 910 can prune a solution space represented by the physical qubits, resulting in a pruned solution space that includes candidate physical qubits. Here, the candidate physical qubits represent a subset of the full set of physical qubits that includes less than all of the full set of physical qubits. By way of example, the solution space reduction component 910 can employ a simple minimum threshold for each likelihood, or any other suitable factor, to prune the original embedding problem size into a reduced version, e.g., by eliminating unpromising edges or nodes. This reduced version can then be provided to the physical graph construction component 920, which can determine a mapping from the original problem graph to a final physical graph using the pruned solution space, e.g., via any suitable algorithm for the minor embedding problem.

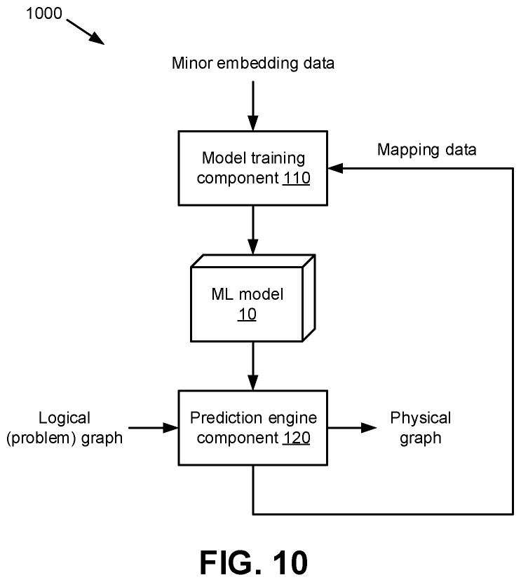

Referring next to FIG. 10, a block diagram of a system 1000 that facilitates supplementation of model training data with prediction engine output is illustrated. Repetitive description of like parts described above with regard to other implementations is omitted for brevity. System 1000 as shown in FIG. 10 includes a model training component 110 and a prediction engine component 120 that can operate with respect to a ML model 10 in a similar manner to that described above with respect to FIG. 1. As further shown by FIG. 10, the prediction engine component 120 can, in addition to using the ML model 10 to obtain a mapping from a logical graph to a physical graph, provide the predicted mapping to the model training component 110 for use as additional training data. For instance, the prediction engine component 120 can make a recommendation for a given mapping and then determine how the mapping performed, e.g., in terms of fidelity of results, runtime, or other factors. Based on this performance data, the model training data 110 can influence the ML model 10, e.g., by making the ML model 10 more likely to suggest solutions that performed well, and/or less likely to suggest solutions that performed poorly, based on the utilized factors.

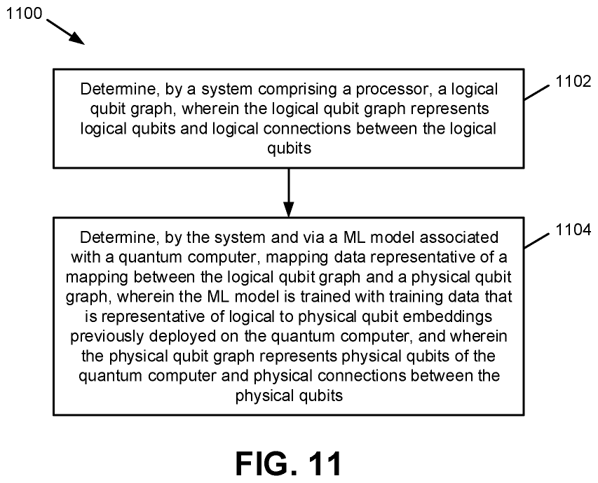

Turning now to FIG. 11, a flow diagram of a method 1100 that facilitates machine learning for solving quantum annealing hardware minor embedding problems is illustrated. At 1102, a system comprising a processor can determine (e.g., via a prediction engine component 120) a logical qubit graph, where the logical qubit graph represents logical qubits and logical connections between the logical qubits (e.g., a problem graph representing a graph problem).

At 1104, the system can determine (e.g., by a prediction engine component 120), via an ML model (e.g., a ML model 10) associated with a quantum computer, mapping data representative of a mapping between the logical qubit graph determined at 1102 and a physical qubit graph. Here, the ML model is trained (e.g., by a model training component 110 and/or other suitable components) with training data representative of logical to physical qubit embeddings that were previously deployed on the quantum computer, and the physical qubit graph represents physical qubits of the quantum computer and physical connections between the physical qubits.

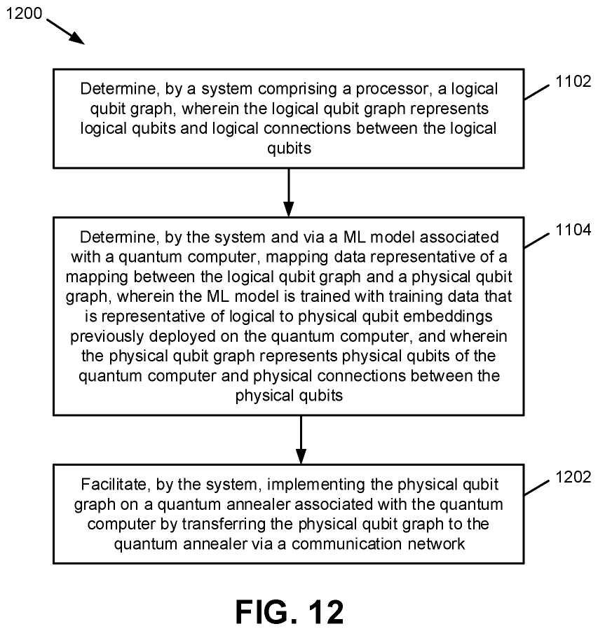

Referring next to FIG. 12, a flow diagram of a method 1200 that facilitates execution of a mapped physical qubit graph on an associated quantum annealer is illustrated. Method 1200 begins by performing the operations at 1102 and 1104 in a similar manner to that described above with respect to FIG. 11. Method 1200 then proceeds from 1104 to 1202. in which the system facilitates (e.g., by an embedding component 510) implementing the physical qubit graph for which a mapping was determined at 1104 on a quantum annealer (e.g., a quantum annealer 20) associated with the quantum computer by transferring the physical qubit graph to the quantum annealer via a communication network (e.g., a communication network 30).

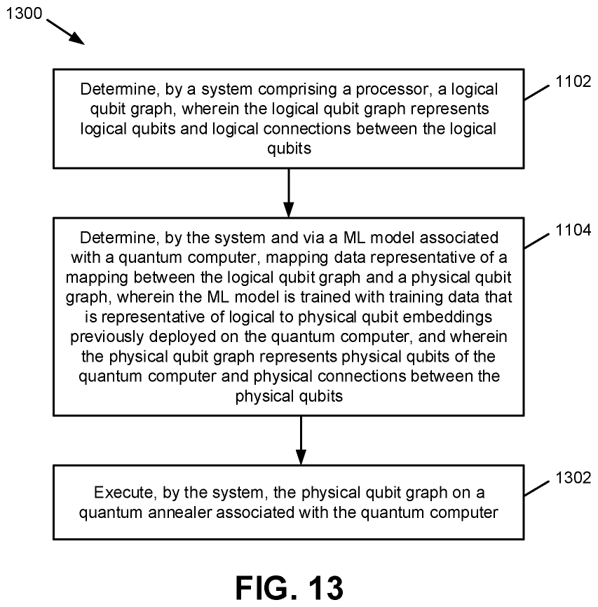

Turning to FIG. 13, a flow diagram of another method 1300 that facilitates execution of a mapped physical qubit graph on an associated quantum annealer is illustrated. Method 1300 begins by performing the operations at 1102 and 1104 in a similar manner to that described above with respect to FIG. 11. Method 1300 then proceeds from 1104 to 1302, in which the system executes (e.g., by an embedding component 510) the physical qubit graph for which a mapping was determined at 1104 on a quantum annealer (e.g., a quantum annealer 20) associated with the quantum computer (e.g., a quantum hardware device 40).

FIGS. 11-13 as described above illustrate methods in accordance with certain embodiments of this disclosure. While, for purposes of simplicity of explanation, the methods have been shown and described as series of acts, it is to be understood and appreciated that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain embodiments of this disclosure.

In order to provide additional context for various embodiments described herein, FIG. 14 and the following discussion are intended to provide a brief, general description of a suitable computing environment 1400 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 14, the example environment 1400 for implementing various embodiments described herein includes a computer 1402, the computer 1402 including a processing unit 1404, a system memory 1406 and a system bus 1408. The system bus 1408 couples system components including, but not limited to, the system memory 1406 to the processing unit 1404. The processing unit 1404 can be any of various commercially available processors. Dual microprocessors and other multi-processor architectures can also be employed as the processing unit 1404.

The system bus 1408 can be any of several types of bus structure that can further interconnect to a memory bus (with or without a memory controller), a peripheral bus, and a local bus using any of a variety of commercially available bus architectures. The system memory 1406 includes ROM 1410 and RAM 1412. A basic input/output system (BIOS) can be stored in a non-volatile memory such as ROM, erasable programmable read only memory (EPROM), EEPROM, which BIOS contains the basic routines that help to transfer information between elements within the computer 1402, such as during startup. The RAM 1412 can also include a high-speed RAM such as static RAM for caching data.

The computer 1402 further includes an internal hard disk drive (HDD) 1414 (e.g., EIDE, SATA), one or more external storage devices 1416 (e.g., a magnetic floppy disk drive (FDD), a memory stick or flash drive reader, a memory card reader, etc.) and an optical disk drive 1420 (e.g., which can read or write from a CD-ROM disc, a DVD, a BD, etc.). While the internal HDD 1414 is illustrated as located within the computer 1402, the internal HDD 1414 can also be configured for external use in a suitable chassis (not shown). Additionally, while not shown in environment 1400, a solid state drive (SSD) could be used in addition to, or in place of, an HDD 1414. The HDD 1414, external storage device(s) 1416 and optical disk drive 1420 can be connected to the system bus 1408 by an HDD interface 1424, an external storage interface 1426 and an optical drive interface 1428, respectively. The interface 1424 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1402, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1412, including an operating system 1430, one or more application programs 1432, other program modules 1434 and program data 1436. All or portions of the operating system, applications, modules, and/or data can also be cached in the RAM 1412. The systems and methods described herein can be implemented utilizing various commercially available operating systems or combinations of operating systems.

Computer 1402 can optionally comprise emulation technologies. For example, a hypervisor (not shown) or other intermediary can emulate a hardware environment for operating system 1430, and the emulated hardware can optionally be different from the hardware illustrated in FIG. 14. In such an embodiment, operating system 1430 can comprise one virtual machine (VM) of multiple VMs hosted at computer 1402. Furthermore, operating system 1430 can provide runtime environments, such as the Java runtime environment or the. NET framework, for applications 1432. Runtime environments are consistent execution environments that allow applications 1432 to run on any operating system that includes the runtime environment. Similarly, operating system 1430 can support containers, and applications 1432 can be in the form of containers, which are lightweight, standalone, executable packages of software that include, e.g., code, runtime, system tools, system libraries and settings for an application.

Further, computer 1402 can be enable with a security module, such as a trusted processing module (TPM). For instance with a TPM, boot components hash next in time boot components, and wait for a match of results to secured values, before loading a next boot component. This process can take place at any layer in the code execution stack of computer 1402, e.g., applied at the application execution level or at the operating system (OS) kernel level, thereby enabling security at any level of code execution.

A user can enter commands and information into the computer 1402 through one or more wired/wireless input devices, e.g., a keyboard 1438, a touch screen 1440, and a pointing device, such as a mouse 1442. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1404 through an input device interface 1444 that can be coupled to the system bus 1408, but can be connected by other interfaces, such as a parallel port, an IEEE 1394 serial port, a game port, a USB port, an IR interface, a BLUETOOTH® interface, etc.

A monitor 1446 or other type of display device can be also connected to the system bus 1408 via an interface, such as a video adapter 1448. In addition to the monitor 1446, a computer typically includes other peripheral output devices (not shown), such as speakers, printers, etc.

The computer 1402 can operate in a networked environment using logical connections via wired and/or wireless communications to one or more remote computers, such as a remote computer(s) 1450. The remote computer(s) 1450 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1452 is illustrated. The logical connections depicted include wired/wireless connectivity to a local area network (LAN) 1454 and/or larger networks, e.g., a wide area network (WAN) 1456. Such LAN and WAN networking environments are commonplace in offices and companies, and facilitate enterprise-wide computer networks, such as intranets, all of which can connect to a global communications network, e.g., the Internet.

When used in a LAN networking environment, the computer 1402 can be connected to the local network 1454 through a wired and/or wireless communication network interface or adapter 1458. The adapter 1458 can facilitate wired or wireless communication to the LAN 1454, which can also include a wireless access point (AP) disposed thereon for communicating with the adapter 1458 in a wireless mode.

When used in a WAN networking environment, the computer 1402 can include a modem 1460 or can be connected to a communications server on the WAN 1456 via other means for establishing communications over the WAN 1456, such as by way of the Internet. The modem 1460, which can be internal or external and a wired or wireless device, can be connected to the system bus 1408 via the input device interface 1444. In a networked environment, program modules depicted relative to the computer 1402 or portions thereof, can be stored in the remote memory/storage device 1452. It will be appreciated that the network connections shown are example and other means of establishing a communications link between the computers can be used.

When used in either a LAN or WAN networking environment, the computer 1402 can access cloud storage systems or other network-based storage systems in addition to, or in place of, external storage devices 1416 as described above. Generally, a connection between the computer 1402 and a cloud storage system can be established over a LAN 1454 or WAN 1456 e.g., by the adapter 1458 or modem 1460, respectively. Upon connecting the computer 1402 to an associated cloud storage system, the external storage interface 1426 can, with the aid of the adapter 1458 and/or modem 1460, manage storage provided by the cloud storage system as it would other types of external storage. For instance, the external storage interface 1426 can be configured to provide access to cloud storage sources as if those sources were physically connected to the computer 1402.

The computer 1402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any embodiment or design described herein as “exemplary” and/or “demonstrative” is not necessarily to be construed as preferred or advantageous over other embodiments or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
a memory that stores executable components; and
a processor that executes the executable components stored in the memory, wherein the executable components comprise:
a prediction engine component that determines, via a machine learning model associated with a quantum hardware device and based on a logical graph corresponding to logical qubits and logical connections between the logical qubits, a mapping from the logical graph to a physical graph, the physical graph corresponding to physical qubits of the quantum hardware device and physical connections between the physical qubits, wherein the machine learning model is trained via a model training component using minor embedding data, and wherein the minor embedding data is representative of logical to physical qubit mappings previously used by the quantum hardware device.

2. The system of claim 1, wherein the executable components further comprise:
an embedding component that enables execution of the physical graph via a quantum annealer associated with the quantum hardware device, resulting in the physical qubits of the quantum hardware device being configured according to the physical graph.

3. The system of claim 2, wherein the system is communicatively coupled to the quantum hardware device via a communication network, and wherein the embedding component transfers the physical graph to the quantum annealer via the communication network.

4. The system of claim 2, wherein the quantum hardware device comprises the system, and wherein the embedding component executes the physical graph on the quantum annealer.

5. The system of claim 1, wherein the machine learning model is a first machine learning model, wherein the minor embedding data is first minor embedding data, wherein the quantum hardware device is a first quantum hardware device, and wherein the model training component further trains a second machine learning model associated with a second quantum hardware device using second minor embedding data associated with the second quantum hardware device, the first quantum hardware device being different from the second quantum hardware device.

6. The system of claim 1, wherein the machine learning model comprises parameters associated with a hardware topology of the quantum hardware device.

7. The system of claim 1, wherein the prediction engine component determines probability values, representative of likelihoods of respective ones of the physical qubits and the physical connections being in the physical graph.

8. The system of claim 7, further comprising:
a solution space reduction component that prunes a solution space represented by the physical qubits based on the probability values, resulting in a pruned solution space comprising candidate physical qubits of the physical qubits, the candidate physical qubits comprising less than all of the physical qubits; and
a physical graph construction component that determines the mapping from the logical graph to the physical graph using the pruned solution space.

9. The system of claim 1, wherein the prediction engine component provides, to the model training component, the mapping from the logical graph to the physical graph, and wherein the model training component supplements the minor embedding data with the mapping.

10. The system of claim 1, wherein the machine learning model comprises a graph neural network.

11. A method, comprising:
determining, by a system comprising a processor, a logical qubit graph, wherein the logical qubit graph represents logical qubits and logical connections between the logical qubits; and
determining, by the system and via a machine learning model associated with a quantum computer, mapping data representative of a mapping between the logical qubit graph and a physical qubit graph, wherein the machine learning model is trained with training data that is representative of logical to physical qubit embeddings previously deployed on the quantum computer, and wherein the physical qubit graph represents physical qubits of the quantum computer and physical connections between the physical qubits.

12. The method of claim 11, further comprising:
facilitating, by the system, implementing the physical qubit graph on a quantum annealer associated with the quantum computer, resulting in the physical qubits of the quantum computer being configured according to the physical qubit graph.

13. The method of claim 12, wherein the system is communicatively coupled to the quantum annealer via a communication network, and wherein the method further comprises:
transferring, by the system, the physical qubit graph to the quantum annealer via the communication network.

14. The method of claim 12, wherein the quantum computer comprises the system, and wherein the facilitating of the implementing comprises executing the physical qubit graph on the quantum annealer.

15. The method of claim 11, wherein the determining of the mapping data comprises determining the mapping data via the machine learning model and according to a loss function, the loss function comprising a first term representative of a level of correlation between the physical qubit graph and the logical qubit graph and a second term representative of a total number of the physical qubits used in the physical qubit graph.

16. The method of claim 11, further comprising:
supplementing, by the system, the training data with the mapping data.

17. A non-transitory machine-readable medium comprising computer executable instructions that, when executed by a processor, facilitate performance of operations, the operations comprising:
receiving problem graph data representative of a problem graph comprising logical qubits and logical connections between the logical qubits; and
determining, via a neural network generated for a quantum computing device, mapping data representative of a mapping from the problem graph to a physical qubit graph, wherein the neural network is trained using minor embedding data representative of logical to physical qubit mappings previously used by the quantum computing device, and wherein the physical qubit graph is representative of physical qubits of the quantum computing device and physical connections between the physical qubits.

18. The non-transitory machine-readable medium of claim 17, wherein the operations further comprise:
facilitating executing the physical qubit graph via a quantum annealer of the quantum computing device, resulting in the physical qubits of the quantum computing device being configured according to the physical qubit graph.

19. The non-transitory machine-readable medium of claim 18, wherein the operations further comprise:
communicatively coupling to the quantum annealer via a communication network, wherein the facilitating of the executing comprises providing the physical qubit graph to the quantum annealer via the communication network.

20. The non-transitory machine-readable medium of claim 18, wherein the quantum computing device is operatively coupled to the processor, and wherein the facilitating of the executing comprises executing the physical qubit graph via the quantum annealer.
